(19) United States
(12) Patent Application Publication
(10) Pub. No.: US 2007/0016430 A1
(43) Pub. Date: Jan. 18, 2007

(54) Method for selection of cosmetic products

(76) Inventor: Galina Goustova, Brooklyn, NY (US)

Correspondence Address: Steven Horowitz;Counselor At Law, Suite 700, 295 Madison Avenue, New York, NY, 10017, US

(21) Appl. No.: 11/180,229

(22) Filed: Jul. 13, 2005

(51) Int. Cl. G06Q 99/00; G06Q 30/00

(52) U.S. Cl. 705/1; 705/26

(57) ABSTRACT

A method and system for helping purchasers access immediate, reliable, comprehensive information about the safety of all ingredients in a cosmetic product and the overall safety of the product utilizes a Safety Factor. An interactive web site controlled by software has access to a database of scientifically reliable safety data regarding known cosmetic product ingredients from international sources and is programmed to display a safety factor of a cosmetic product, a list of cosmetic products in a particular product category ranked by safety factor, safety data as to a degree of safety of an ingredient used in a cosmetic product including at least a status of the ingredient as unsafe or safe, warnings on use, and restrictions on use, the proportion of products of a given brand or manufacturer that have a particular ingredient, and the proportion of products in a given product category that have a particular ingredient.

### FIELD OF THE INVENTION

The field of this invention is methods and systems for selecting cosmetic products in a safe manner

### BACKGROUND OF THE INVENTION AND DISCUSSION OF THE PRIOR ART

In the United States, the FDA is the agency generally charged with regulating cosmetics under the Food, Drug & Cosmetic Act. However, the FDA's legal authority over cosmetics is different from its authority to regulate foods, drugs, biologics, and medical devices. For example, cosmetic products and ingredients are not subject to FDA pre-market approval authority, with the exception of color additives. The FD&C Act does not subject cosmetics to FDA pre-market approval in order to be marketed legally. The FDA does not function as a private testing laboratory, and in order to avoid even the perception of conflict of interest, does not recommend private laboratories to consumers or manufacturers for sample analysis. Manufacturers are not required to register their cosmetic establishments, file data on ingredients, or report cosmetic-related injuries to FDA.

Most consumers would be surprised to learn that the government does not require health studies or pre-market testing for cosmetics and other personal care products before they are sold. The toxicity of product ingredients is scrutinized almost exclusively by a self-policing industry safety committee, the Cosmetic Ingredient Review (CIR) panel. Because testing is voluntary and controlled by the manufacturers, many ingredients in cosmetics products are not safety tested at all.

The absence of government oversight for this $35 billion industry leads to companies routinely marketing products with ingredients that are poorly studied, not studied at all, or worse, known to pose potentially serious health risks. For example, Cosmetic companies sometimes place quasi-drugs as one ingredient of a cosmetic product in order to enhance its effectiveness. For example, the well-known cosmetics manufacturer, Chanel, is believed to incorporate ecdistryn, a quasi steroid, into skin creams. The dangers of these quasi-drugs are not always fully known.

There are over 12.000 ingredients available to manufacturers for use in cosmetics and toiletries. The thousands are known to have harmful effects, and many of these are subject to some level of legal restriction. This means that more than one out of every four of the ingredients listed on the label of a bottle of shampoo, for instance, or a jar of face cream, is either on the restricted list, or may be harmful in some way. That does not mean that the product is harmful, but simply that there are potential dangers that the user should be aware of.

The words allergy, sensitivity and hypersensitivity are often misunderstood and misused when describing a reaction to some cosmetics and toiletries. If the user's skin frequently reacts to cosmetic ingredients causing irritation such as soreness, itchiness, red blotches or sometimes a rash, it would be fair to say that the user has sensitive skin. These symptoms tend to subside fairly quickly when the affected area is washed or soothing lotions are applied.

If we had to rely solely on the product labeling for our information, the best we could do is hope the product does what it says it will do, hope that it won't contain any of the ingredients that cause our skin irritation and buy it on a trial and error basis. For a while, we might convince ourselves it is working but how many of us would actually take the product back and ask for a refund if it does not work?

The higher cost of a cosmetic product does not necessarily increase safety. Cosmetics may cost us more than we really want to pay. If a cosmetic ingredient may cause an allergic reaction that is one thing but if the cosmetic product contributes to the user's risk of cancer, that's quite another matter. One might rationally choose to take a drug with side effects on the basis of the fact that the risk may be worth it because we may need the drug to regain or maintain our health. But although they may be rewarding psychologically, are cosmetics worth the kind of risks that certain necessary drugs may be worth?

There is reason to believe that consumers want to consider safety in selecting cosmetic products but do not have the information or tools to do so.

Suppose a consumer wanted to assess the safety risk of a cosmetic product he or she was about to buy. If the consumer had no scientific background, the consumer would be at a loss to do so. Even if the consumer had a scientific background, the consumer would have to spend a great deal of time sifting through scientific literature for each ingredient, reaching a conclusion about the product as a whole from the ingredients researched, comparing this conclusion about the cosmetic product with other conclusions about other cosmetic products in the same category, i.e. skin cream, the last step taking a lot of time in itself.

There is a need for the kind of safety data concerning cosmetics that is available for drugs, which data can be usable in a practical way by the consumer. There is a compelling need for a method and system for providing consumers of cosmetics products with instant access, that access usable at a point of purchase, to comprehensive safety data on consumer products including safety factors in order to aid in selecting cosmetic products. There is a further need for such a method and system wherein the safety data incorporates both scientific and anecdotal information.

### SUMMARY OF THE PRESENT INVENTION

A method and system for helping purchasers access immediate, reliable, comprehensive information about the safety of all ingredients in a cosmetic product and the overall safety of the product utilizes a Safety Factor. An interactive web site controlled by software has access to a database of scientifically reliable safety data regarding known cosmetic product ingredients from international sources and is programmed to display a safety factor of a cosmetic product, a list of cosmetic products in a particular product category ranked by safety factor, safety data as to a degree of safety of an ingredient used in a cosmetic product including at least a status of the ingredient as unsafe or safe, warnings on use, and restrictions on use, the proportion of products of a given brand or manufacturer that have a particular ingredient, and the proportion of products in a given product category that have a particular ingredient.

Three years of investigation into the health and safety assessments on more than 12,000 personal care product ingredients found major gaps in the regulatory safety net for these products. To help people use what Applicant learned Applicant developed an online rating system that ranks products on their potential health risks and the absence of basic safety evaluations.

The present invention is easy to use and help consumers avoid many damaging mistakes that can affect your health. One need only obtain the cosmetic product and read or obtain its list of ingredients, both active and inactive, click on the button activating the program used in the present invention and type the name of ingredients.

One goal of the present invention is to provide cosmetic purchasers with comprehensive safety information about cosmetic products, both products never before purchased and products that you already have at home and use every day. Cosmetic products consist not only from make-up and skin maintenance products for women, but also include products for men and children, shampoos, tooth pastes, deodorants, mouth washes, etc. The method and system of the present invention seeks to inform cosmetic product purchasers about the overall cosmetic product situation and provide a general understanding about cosmetic products, its chemical compositions and purpose of its ingredients. Having this information will make it much easier to understand packaging ingredients and the purpose they serve in the cosmetic product.

The database of the present invention covers currently existing ingredients used in today's cosmetic products. This database was compiled based on two main worldwide known sources: International Cosmetic Ingredient Dictionary and Handbook (herein referred to as the “Dictionary”. The Dictionary defines ingredients and their common names used in the US. The second main source is Cosmetic Directive, which is for ingredients and their names used in Europe. The user will be able to become familiar with what function each ingredient has in a given cosmetic product. It is noted that the same ingredient in different products could have different functions. It depends solely on producers of cosmetics and on people who creates a composition (i.e. a formula) of a cosmetic product. Since the program used in the present invention is designed for the public rather than for chemists specializing in cosmetics' chemical formulas, the program does not review the chemical formula of a cosmetic product or evaluate its quality based on chemical parameters.

A cosmetic product can be described as a chemical formula. Each and every ingredient written on a packaging carton for a cosmetics product has its own name and serves a certain purpose. Europeans and Americans define cosmetic products differently and apply two different approaches. In the United States, there is a clear separation between cosmetics and medical cosmetics. For example, in the United States, sun protective products are considered medical cosmetics and are sold in pharmacies without prescriptions as over-the-counter drugs. In Europe, the same products are classified simply as cosmetics.

Many countries have regulatory requirements for cosmetics that are different from those for products that may function as drugs or that have medicinal properties. Frequently, countries also define the cosmetic and drug functions differently. In general, a substance or product that is intended to significantly affect the structure or function of the body or the treat or cure disease is regulated as a drug. In contrast, a substance or a product that is intended to cleanse, promote attractiveness, or temporarily alter the appearance of the body is regulated as a cosmetic product. The intended function for an ingredient is determined on the basis of claims made by the supplier of the ingredient; in the case of a finished product, claims made for the product. Some functions listed in the Dictionary, which applied to the cosmetic product, may cause products containing them to be subject to drug, quasi-drug, “functional,” or other regulations in addition to-the basic regulations required for cosmetics. Examples of such functions in the U.S. are: antiacne, anticaries, antidandruff, antifungals, antimicrobials, antiperspirants, corn/callus/wart removers, drug astringents, oral health care drugs, skin protectants, external analgesics, oral care agents, oral health care drugs, skin bleaching agents, skin protectants, and sunscreens. In addition, a product, based on its labels, may be subject to both the cosmetic and drug regulations in some countries.

Functions of ingredients listed in the Dictionary are classified on the basis of the function each ingredient may perform in a finished product. Many ingredients have multiple functions in formulas and therefore are included in several functional groups. The definition and scope of each function listed in the Dictionary is provided in Section 4, Functions. The use of an ingredient for a function other than those listed in the Dictionary is acceptable. The inclusion of an ingredient under a given function in the Dictionary does not imply that the ingredient is “approved,” “certified,” or “endorsed” for that use by the CTFA or any other organization or governmental body in the US, the EU, Japan or any other country.

The regulatory approach dealing with the distinction of a cosmetic product from a drug varies from country to country. In the United States, drug ingredients are regulated by the Food and Drug Administration under regulations associated with the United States over-the-counter (OTC) Drug ingredients. In the United States OTC drugs require pre-market approval for safety and efficacy. Some OTC active drug ingredients in the US have been reported to have a purely cosmetic purpose in cosmetic formulas in addition to being safe and effective drug ingredients.

Some United States OTC drug functions may be regulated as cosmetics in other countries. Such functions may therefore be assigned to ingredients not approved for such use in the U.S. In Section 4, Functions, in the Dictionary ingredients approved for use as U.S. active ingredients are identified with an asterisk. When a drug name used in the U.S. differs from the INCI name, the drug name used in the U.S. is listed parenthetically.

In the European Union (“EU”), the key legislation is provided in the Cosmetic Directive that contains a series of Annexes setting out the lists of substances subject to prohibitions as well as substances that are subject to restrictions or are provisionally allowed. Medical products are regulated in the EU by Directive 65/65/EEC. In the EU, as in the U.S., information a product's label define how this product will be regarded under the Directive. Annex I of the Cosmetic Directive identifies products such as antiperspirants, oral care and skin whitening agents as illustration of products that belong to a cosmetic category in the EU, categories that are regarded in the U.S. as OTC drugs.

In Japan, cosmetic products are regulated by the Ministry of Health, Labor and Welfare (MHLW) under the Pharmaceutical Affairs Law. This regulation of cosmetics is summarized in an MHLW publication entitled: Guide to Quasi Drug and Cosmetic Licensing Requirements. Japan has a similar cosmetic and drug distinction as the U.S. and the EU. In addition, it has a category of products referred to as “quasi-drugs” that by definition have a mild effect on the human body.

Many other countries follow the regulations of the EU, Japan, or the U.S. for selected requirements of those countries.

The present invention provides users with information collected from international sources about cosmetic products—everything they need to know about a variety of cosmetic products that the consumer may already have at home and use daily. This way the consumer can determine how good and safe from a health stand point his or her cosmetic products are and what the possible side effects are from that product. The information is gathered from public domain literature. Certain government organizations provide information about all known ingredients and determine how each ingredient to be used.

The present invention allows you to check your cosmetic product based on ingredients on its packaging. One can also search a cosmetic product using manufacturer's name, brand name, type of cosmetic product (intended use), its ingredients and its Safety Factor.

The user of the web site of the present invention also has an opportunity to provide feedback on cosmetic products used. In certain preferred embodiments, anecdotal evidence is combined with scientific research to reach a safety factor.

### IMPORTANT OBJECTS AND ADVANTAGES

The following important objects and advantages of the present invention are:

(1) to provide a system and method of selecting cosmetic products that informs the purchaser of comprehensive safety data about the cosmetic product being considered for purchase;

(2) to provide such a method and system of selecting cosmetic products that is easy to use and does not require a scientific background;

(3) to provide a method and system of selecting cosmetic products that saves time by avoiding the time involved in having to return cosmetic products due to adverse reactions;

(4) to provide a method and system of selecting cosmetic products that saves money by being better informed about cosmetic products before you buy them to avoid having to return them due to adverse reactions;

(5) to provide a method and system of selecting cosmetic products that provides useful comparisons between cosmetic products relating to their safety;

(6) to provide a method of selecting cosmetic products that includes a numerical descriptor of safety for each cosmetic product;

(7) to provide such a method that incorporates safety data from international scientific sources of the highest caliber;

(8) to provide such a method that can combine reliable scientific safety data with up-to-date anecdotal evidence of safety hazards;

(9) to provide such a method and system that allows cosmetic product purchasers to rapidly find products having unacceptably high safety factor;

(10) to provide such a method and system that includes an interactive web site that can handle inputting of ingredients in any of various forms commonly used in any country;

(11) to provide such a method and system that motivates cosmetic product consumers to think about safety and increase their level of knowledge of dangers associated with the ingredients in cosmetic products;

(12) to provide such a method and system that makes it more likely that cosmetic product manufacturers will user safer ingredients in the products they sell;

(13) to provide a method and system that educates consumers of cosmetic products as to which brand names of a particular type of cosmetic product to avoid;

(14) to provide a method and system that provides users with statistical information as to how often a particular cosmetic product ingredient appears in the cosmetic products of a certain cosmetic manufacturer;

(15) to provide a method and system wherein cosmetic product purchasers can request and obtain a list of cosmetic products of a particular product category or manufacturer/brand ranked by safety factor;

(16) to provide a method and system wherein a cosmetic product purchaser can request and obtain the number of cosmetic products in each particular product category (i.e. shaving creams) that contain a particular ingredient; and

(17) to provide such a method and system wherein cosmetics purchasers can access and obtain immediate, reliable and comprehensive information about the safety of a particular cosmetic product and its ingredients.

### BRIEF DESCRIPTION OF THE DRAWINGS

FIG. 1 is a chart showing the basic elements of the system of the present invention.

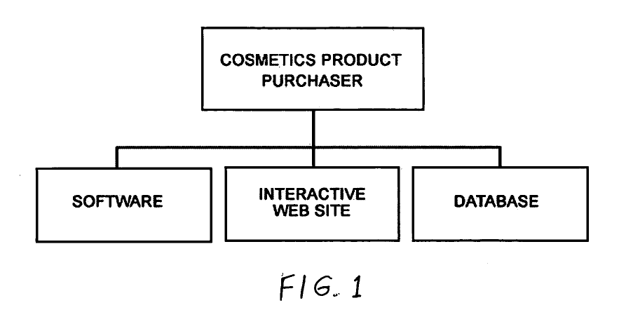

### DETAILED DESCRIPTION OF THE PREFERRED EMBODIMENT

The method and system of the present invention will now be illustrated in further detail, including through the provision of examples.

A “cosmetic product” is defined to mean any substance or preparation intended for placing in contact with the various external parts of the human body (epidermis, hair system, nails, lips and external genital organs) or with the teeth and the mucous membranes of the oral cavity with a view exclusively or principally to cleaning them, perfuming them or protecting them in order to keep them in good condition, change their appearance or correct body odors. This definition is based upon the Directive 76/768/EEC issued by the European Union's Encyclopedia of Cosmetics.

Industries' researches make sure that our databases contain the most up to date information on every known cosmetic line and its ingredients. With such valuable facts, we are able to estimate the Safety Factor of every cosmetic product based on the information we obtain. Using the program of the method and system of the present invention provide the user with a Safety Factor or score for a particular cosmetic product, and will open doors to the vast amount of vital information and get the in-depth resources needed in making an informed and educated decision before spending money on any cosmetic product.

A score is given to the safety of the cosmetic product that the user is considering purchasing. The score is sometimes referred to as a “Safety Factor”. The score or Safety Factor is measured on a scale from 0 to 100: the higher the score—the better and healthier the cosmetic product. Thus, a score of “100” means that the given cosmetic product does not have any ingredients dangerous for human health. The lower the score or “Safety Factor”—the higher the number of dangerous ingredients appear in the given cosmetic product. A higher Safety Factor does not mean that this cosmetic product is toxic but rather that there is a higher percentage of dangerous ingredients appearing in the cosmetic product based on information already known about these ingredients.

The program used in the method and system of the present invention counts the total number of ingredients in the particular cosmetic product. Then, from the program counts the number of ingredients of that total that might present some kind of danger. In addition, the program advises the user of the nature of the danger. The program does not, however, grade the ingredient based on the level of danger it might have. That would be virtually impossible since each person is an individual and the same cosmetic product will have different results on different people. Accordingly, grading the level of the danger from an ingredient is not part of what the program does but is rather left to medical practitioners and researchers to decide.

Each safe ingredient in the cosmetic product receives a weight multiple of “100”, which represents the highest safety level. Each dangerous ingredient in the cosmetic product receives a weight multiple of “0”, which represents the lowest safety level. The resulting numbers associated with each ingredient are added together and the resulting sum is divided by the total number of ingredients.

For example:
Total number of ingredients in a cosmetic product—15, including:
number of safe ingredients—12, number of dangerous ingredients—3.
Calculations: 12×100+3×0=1200=>1200/15=80
SafetyFactor—80
   As a result that cosmetic product receives a representing how safe it is of “80”.

Besides a “Safety Factor”, the user at the web site also receives detailed information about the type and level of dangers associated with the ingredients of the cosmetic product. This detailed information is both in the form of text and also graphicly represented. For example, safe ingredients marked with a green color. In contrast ingredient known to be dangerous are marked in red color. Also marked in red color are ingredients that might have some danger either because there is not enough information available about them or because there is a known danger associated with them at a certain level of concentration of the ingredient which level is higher than the level present in the cosmetic product.

The program used in the method and system of the present invention designates such ingredients that are in the latter category by marking them in red color and assigning a weight multiple of “100” in calculating the “Safety Factor” because the program operates by being on the safe side. Each cosmetic product is a complex chemical formula with many components, and consumers want to have as much information as possible not to cause any harm to our health.

Furthermore, if an ingredient is not in the database of the program used herein or a manufacturer took a risk and used an ingredient that is not registered with the International Nomenclature Cosmetic Ingredient (INCI), then this ingredient is considered as possibly dangerous. If there was a mistake in an ingredient's name, then this mistake will be corrected when ingredient will be added to the database and SafetyFactor will also change.

Ingredients marked with red color have written evidence proving that they are toxic and might be dangerous for consumers. Sources of information used to determine the danger of ingredients could be looked at in References. “Red” ingredients have been given a score of 0: because since danger and toxic effect of each ingredient is different for each person, the program does not grade the ingredient on the exact level of their danger. These ingredients get 0 score,

Some of the ingredients in cosmetic products have negative effects on a human skin as well as on a whole body. Scientists are constantly conducting research studies to prove that certain ingredients in cosmetic products are unsafe. In Applicant's research it has been found that ingredients, whose effects are disputable among scientists as to what danger they present, fall into two distinct categories. The first category is those ingredients whose danger has been experimentally proven and about which many research papers have been published. The second category is ingredients as to which a danger has been generally acknowledged but while there is research that proves the danger, but there is no official consensus about the danger of the ingredient.

Consequently, the program draws on a database that includes all existing information encompassing both the description of the danger as well as references to original research sources so every purchaser of cosmetic products can make his/her purchasing decision with full informed consent based upon all the warnings that the program provides. The goal is not only to inform purchasers of cosmetic products about existing dangers inherent in certain ingredients, and to increase consumers' knowledge about cosmetic products and tendency to be motivated about safety but also to stimulate cosmetic product manufacturers to make safer cosmetic products.

The method and system of the present invention divides the information presented concerning the safety of cosmetic products into four groups.

GROUP I: Warnings. These are ingredients that have of the below-listed 18 warnings associated with them. Ingredients in this Group receive a weight multiple or Score of 0.

The WARNINGS themselves have been divided into the following 18 categories:

1. Concentration limits. ‘Safe’ with concentration known to be safe.
2. Do not use on broken skin. Unsafe for use on injured or damaged skin
3. Harmful impurities. May contain harmful impurities linked to cancer and other serious health impacts.
4. Insufficient testing data. Unable to determine if the ingredient was safe for use in cosmetics or not.
5. May be carcinogens, mutagens or toxic. Possible has carcinogenic, mutagenic and toxic effects but the available information is not adequate for making a satisfactory determination.
6. May be Comedogenic. Acne promoting
7. May be eye irritant. May cause irritation to the eyes and mucous membrane
8. May be phototoxic. May increase risk of photosensitivity.
9. May be unsafe on infant skin. Do not use in children under three years of age.
10. May cause allergy/contact dermatitis. May be skin irritant.
11. May cause eczema. (Atopic dermatitis)
12. May cause sensitization via inhalation. Insufficient data to determine safety of products where ingredients are likely to be inhaled.
13. May cause skin sensitivity.
14. May form nitrosamines. In combination with other chemicals can form nitrosamines.
15. May contain impurities, linked to breast cancer.
16. Penetration enhancer. Penetration enhancer that might increase exposures to carcinogens and other ingredients of concern.
17. Reproductive Toxics/Endocrine Disruptor. May harm health by affecting the human endocrine or reproductive system.
18. Unsafe to Leave On. Unsafe when used in products that are left on the skin, and not immediately rinsed off after an initial use.
   Group II: Unsafe

There is a sufficient evidence to establish a direct connection between human exposure to this substance and development of cancer.

Ingredients in this UNSAFE Group receive a weight multiple or Score of 0

Group UNSAFE Includes:

Category 1 or 2: Carcinogenic, Mutagenic and Toxic

Substances classified according to Council Directive 67/548/EEC as carcinogens, mutagens or toxic category 1 or 2 (except substances only carcinogenic by inhalation), and substances with similar potentials, must not be intentionally added to cosmetic products.

There is sufficient evidence to establish a causal association between human exposure to a substance and the development of cancer.

The Tenth Report on Carcinogens (RoC)

U.S. Department of Health and Human Services

National Toxicology Program

The Report on Carcinogens (RoC) is an informational scientific and public health document that identifies and discusses substances (including agents, mixtures, or exposure circumstances) that may pose a carcinogenic hazard to human health. It serves as a meaningful and useful compilation of data on (1) the carcinogenicity (whether it causes cancer), genotoxicity (whether it causes damage to genes), and biologic mechanisms (how it works in the body) of the listed substances in people and/or in animals, (2) the potential for human exposure to these substances, and (3) Federal regulations to limit exposures.

The RoC does not present quantitative assessments of the carcinogenic risk of these substances. Listing of substances in the RoC, therefore, does not establish that these substances present carcinogenic risks to individuals in their daily lives. Such formal risk assessments are the responsibility of the appropriate federal, state, and local health regulatory and research agencies. The substances listed in the RoC are either known or are reasonably anticipated to cause cancer in humans under certain exposure circumstances. In many cases, cancers resulting from exposures to the listed substances may require exposures for prolonged periods of time. For example, smoking tobacco is known to cause cancer in humans; however, not all people who smoke develop smoking-related cancers. Some substances or circumstances, however, need only short exposures to cause cancer.

Examples include certain occupational exposures to asbestos or bis(chloromethyl) ether. The carcinogenic hazard that listed substances pose to any one person depends on many factors. Among these are the amount and duration of exposure to the substance, an individual's susceptibility to the carcinogenic action of the substance, and the intrinsic carcinogenicity of the substance. Because of these considerations, the RoC does not attempt to rank substances according to the relative carcinogenic hazards.

The following are reference used by the program used in the method and system of the present invention relating to Group Unsafe ingredients.
htt://ehp.niehs.nih.gov/roc/toc10.html#toc
Ingredients found unsafe for use in cosmetics (Expert Panel, 2004)
The Cosmetics Ingredient Review (CIR) (2004)
http://www.cir-safety.org/staff_files/unsafe.pdf
   GROUP III: Prohibited and Restricted

Prohibited Ingredients—Substances which must not be a part of cosmetic products' composition.

Restricted Ingredients—Substances which must be restricted from use in cosmetic products subject to restrictions and conditions laid down . . .

Ingredients in this Group receive a weight multiple or Score of 0

Among the important differences between requirements for cosmetics in the U.S. and various other countries are the legal definitions of drugs and cosmetics, restrictions on the use of color additives and other ingredients, and registration requirements.

Some products regulated as cosmetics in Europe, for instance, are regulated as drugs in the U.S. Sunscreens are a case in point. There also are differences regarding prohibited and restricted ingredients, particularly color additives.

Some countries may require cosmetic companies to register their establishments and list products and ingredients with the government; in the U.S., cosmetic registration is voluntary but highly recommended.
http://vm.cfsan.fda.gov/˜dms/cosuslaw.html
   GROUP IV: Safe as Used

Ingredients in this Group receive a weight multiple or Score of 100.

The Cosmetic Ingredient Review (CIR) published its 2004 CIR Compendium, which contains concise information on nearly 1,200 safety assessments of individual cosmetic ingredients. ‘The CIR Compendium is a must for dermatologists, chemists, toxicologists, and industry and consumer safety groups,’ said Wilma Bergfeld, M. D., chair of CIR's Expert Panel and head of clinical research and dermatopathology at The Cleveland Clinic's Department of Dermatology.

Established in 1976 by the Cosmetic, Toiletry, and Fragrance Association (CTFA), the CIR independently reviews the safety of ingredients used in cosmetics in an open public forum. The CIR Expert Panel's formal decision regarding the safety of an ingredient, and the basis for that decision, is made publicly available in a safety assessment monograph. The CIR Compendium is a compilation of information taken from CIR's safety assessments.
http//cosmeticentry.com/fito.php?do=test&op=rules

The program used in the method and system of the present invention provides guidelines to the user to input information about the cosmetic products. In one preferred embodiment, the Guidelines include the following type of language outlined below which language has been described in a form of actual language directed to a user appearing on the interactive web site used in the method and system of the present invention:

Guidelines:

Before you begin, we would like to ask you to read search guidelines and to learn about search criteria—the fields you will need to fill out to get the best results. This will save you time and will help to avoid frustration.

Please remember—fields marked with red asterisk are required to be filled out, all others could be left blank. In our search guidelines we provide description of each field with necessary information and comments.

Identity of Manufacturer—it is not a required field, but it is recommended to fill this field out. Sometimes it is difficult to determine a cosmetic product's manufacturer by looking on its packaging because it may not be listed or original manufacturer may produce many different cosmetic lines. For example, Estee Lauder Companies is a manufacturer of many cosmetic products such as eye, skin and antiperspirant products. It is also a mother company of many cosmetic lines—such as Aramis, Clinique, Prescriptives, Origins, M-A-C, La Mer, Bobbi Brown, Tommy Hilfiger, Jane, Donna Karan, Aveda, Stila, Jo Malone, Bumble and bumble, Kate Spade Beauty, Darphin, Michael Kors, Rodan and Fields.

Brand—it is a required field. It has much higher degree of recognition than manufacturer name. For example, Johnson & Johnson produce more than 200 brands, and among them the best known brands are Johnson's and Aveeno.

Product name—it is a required field. This name is generally located on a packaging of the product or on a cosmetic product's container. For example, brand Aveeno has a cosmetic product with name—Gentle Skin Cleanser for Moisturizing Dry Skin. This name should be written in this field.

Select category—it is a required field. Here you specify the nature of the cosmetic product you are looking for. It is very important to select the closest to your intended use category. Select the type and form of cosmetic product.

Made in—it is not a required field, but if you know—it will be very useful to fill it out. Here you enter a country name where your cosmetic product was made. Many cosmetic companies have production facilities all over the world. The same cosmetic product could be made in Italy, in Philippines or in the US. It is important to know because the same product made in different countries could have different chemical compositions, based on particular country's regulations for use of certain ingredients in cosmetic products. Composition of a cosmetic product from Johnson & Johnson made in Europe could be different from composition of the same product and brand name made by the same producer in the US. For more details, please check Cosmetic Regulations.

Information link—not a required field. Many companies on their websites not only provide list and description of their products, but also provide a list of ingredients. If your information comes from the Internet, it is useful to enter this information.

List of ingredients—it is a required and very important field. Composition (list of ingredients) of any cosmetic product is written on its packaging or enclosed on a piece of paper with the cosmetic product. It is important that each of the ingredients listed is entered on the separate line (new line) in the field and the exactly as it is listed, no commas, colons, dots at the end of each line. It has to be done very carefully: the fewer mistakes made—the better and more precise results of the search.

Our database has about 12000 ingredients and there is a very low probability that an ingredient will not be found. In case if you have made a mistake writing ingredient's name, you can always check back and correct it. You can always use our database of ingredients to find out the right spelling on an ingredient you need.

Directions—it is not a required field. Here you can write a short description of a cosmetic product, how to use it and other useful information.

When you enter all information and search is completed, you will see on a screen the SafetyFactor of your product, and you will be able to read and analyze the safety of your cosmetic product.

Benefits for Users:

Correct Spelling of Ingredient

If you see message “Unknown ingredient” or “Ingredient is not listed in database”, it could mean two things: a mistake in writing an ingredient's name or this particular ingredient is not listed in our database, which contains more than 12000 names of ingredients.

To correct a mistake in writing ingredient's name—check again spelling with ingredient's name on packaging or instruction paper. If there are no mistakes, try to use search system to find this ingredient in our database for ingredients (<a href=′fito.php?do=ingr′>Ingredients Search</a>). If there is a mistake in writing ingredient's name—click the button “Correct your spelling” and make necessary changes in spelling of ingredient's name. After completing all necessary changes, click the button “CosmeticEntry's SafetyFactor” again.

If after making all changes you still get the message “Unknown Ingredient”, it could mean that there is a mistake in ingredient's name on packaging, or manufacturer listed ingredient/s not in accordance with commonly accepted norms or used outdated information. Also it means that the name of this ingredient is not listed in International Cosmetic Ingredient Dictionary and cosmetic Directive.

You can also use option “Advanced Search”, which has more features and might help to find ingredient you are looking for.

Statistics by Brand Names

“Statistics by brand names”. This option shows statistics of use a given ingredient by brand names—how often this ingredient used in cosmetic products of different brand names. It gives you one more option to choose a cosmetic product—based on our statistics by brand names: to buy certain brand names or to avoid them. It will help to save time and money, and will prevent from making wrong decisions.

The option—“See Product Category”. Here you will be able to see table with information about what category of cosmetic products contains this particular ingredient. If you like certain ingredient, or on contrary—do not like certain ingredient, this table will help you to decide what product to buy or to avoid. Also you will be able to learn about how often this ingredient used in certain product category. For example, in the Product Category—Skin Care: Masks in our database there are 25 products, 5 of them contain Kaolin. In other words, 20% of products in this category have Kaolin. Consumer, knowing that his/her skin is particularly sensitive to Kaolin, could avoid products containing this ingredient and should be careful to cosmetic product's composition.

See Product with Ingredient from the Group and Categories:

Here you can find information about cosmetic products widely available on the market—in pharmacies, specialty stores, on the Internet. We created our databases based on information from manufacturers of cosmetic products enclosed with the product and/or listed on its packaging. Part of information has come from visitors like you—people tried to check their own cosmetic product and, while doing it, have added and enriched our databases—for the benefits of themselves and other people. Even though process might be a bit time consuming, all information entered is saved in our databases and classified under different categories—under a cosmetic product name, under a manufacturer name and under a brand name. So the next time you visit this site—you will benefit from your own efforts and efforts of others, each of us helping one another to contribute to the improvement of databases available for all. And this will save time and money by being able to purchase exactly what we need.

Relative Rating with Position Diagram:

The same ingredient could have different names in different countries. For example: regular water in the US is listed as “water”, but in Europe it is listed as “aqua”. Here you can see the current list of ingredients and how they could be listed (their different names) by different manufacturers.

If an ingredient is known to be unsafe at certain concentration levels and the cosmetic product contains the ingredient at lower concentration levels, the safety factor of the cosmetic product will still treat the ingredient as not safe.

The following is an example of a user interaction with the interactive web site using the method and system of the present invention.

### EXAMPLE

A user accesses the interactive web site. The user then is prompted to type in a product name, a brand or manufacturer and a category (the type of product broken down by what the product is intended to be used for). Suppose the user types in the Product name “Detangling Formula”, the Brand name Johnson & Johnson, and the category Baby Shampoo. [Note that if the user leaves out one of these fields, for example, the Product Name, the user can achieve the same result since the user will then be shown various Product Names for the selected Brand and Category chosen. In any case, once the user hits “search”to perform the product search the user will see on the screen the following listing the ingredients along with other selection choices as to what to do as shown in FIG. 2:
Johnson's Baby Shampoo Detangling Formula
Brand: Johnson's [manufactured by Johnson & Johnson]
Country: USA
Category: Baby skin care: Shampoo
   Direction:
Wet hair, apply shampoo, lather and rinse. Repeat.
   Ingredients:
AQUA
COCAMIDOPROPYL BETAINE
PEG-80 SORBITAN LAURATE
SODIUM TRIDECETH SULFATE
PEG-150 DISTEARATE
PARFUM
POLYQUATERNIUM-10
TETRASODIUM EDTA
QUATERNIUM-15
CITRIC ACID
RED 40
YELLOW 10

If the user then selects any of the listed ingredients, for example, Red 40, the user sees the following screen describing that ingredient:

RED 40

Function and Warning!

Cosmetic Ingredient Functions

Colorant/US

Color additives, are those cosmetic ingredients which impart color to the skin or its appendages or are used to color finished products. More info. . .→

On the right hand side of the screen are the following prompts:

Ingredient also may be listed as

The same ingredient could have different names in different countries.

For example: regular water in the US is listed as “water”, but in Europe it is listed as “aqua”. Here you can see the current list of ingredients and how they could be listed (their different names) by different manufacturers.

Statistics by Product Category

This link will list all the cosmetic product categories that included the ingredient under search as one of the ingredients contained in the product.

Statistics by Brands

This link displays all known Brands that use the ingredient searched for in their cosmetic lines.

If the user then selects Statistics by Product Category the user will see a screen that shows the following:

RED 40

See Product Category:

The option—“See Product Category”. Here you will be able to see table with information about what category of cosmetic products contains this particular ingredient. If you like certain ingredient, or on contrary—do not like certain ingredient, this table will help you to decide what product to buy or to avoid. Also you will be able to learn about how often this ingredient used in certain product category. For example, in the Product Category—Skin Care: Masks in our database there are 25 products, 5 of them contain Kaolin. In other words, 20% of products in this category have Kaolin. Consumer, knowing that his/her skin is particularly sensitive to Kaolin, could avoid products containing this ingredient and should be careful to cosmetic product's composition.

| Categories | Statistics |
|---|---|
| Face care: Anti-aging products | 1 of 9 (11%) |
| Hair care: Conditioners (lotions, creams, oils) | 1 of 7 (14%) |
| Hair care: Scalp treatment | 1 to 4 (25%) |
| Baby skin care: Shampoo | 1 of 6 (16%) |
| Oral care: Other products | 1 of 1 (100%) |
| Total: | 5 of 249 (2%) |

If the user selects the choice Statistics by Brand the user will see the following screen:

RED 40

Statistics by Brand Names

in brand names or to avoid them. It will help to save time and money, and will prevent from making wrong decisions. “Statistics by brand names”. This option shows statistics of use of a given ingredient by brand names—how often this ingredient is used in cosmetic products of different brand names. It gives you one more option to choose a cosmetic product—based on our statistics by brand names.

| Brands | Product count |
|---|---|
| Olay [Procter & Gamble] | 2 of 12 (16%) |
| Neutrogena [Johnson & Johnson] | 2 of 19 (10%) |
| Plax | 1 of 1 (100%) |
| Johnson's [Johnson & Johnson] | 1 of 37 (2%) |
| Total | |

If instead of selecting Red 40 the user had selected a different ingredient, for example Citric Acid, from Johnson & Johnson Detangling Formula, the user would have seen the following screen which lists different functions of Citric Acid for cosmetic products and prompts the user to obtain more information:

Citric Acid

Function and Warning!

Cosmetic Ingredient Functions

Buffering agent/EU

Added to cosmetic products to adjust or stabilize the pH thereof. More info. . .→

Chelating agent/EU

Added to cosmetic products to react and to form complexes with metal ions which could affect stability and/or appearance of cosmetics. More info. . .→

Chelating Agent/US

Ingredients that have the ability to complex with and inactivate metallic ions in order to prevent their adverse effects on the stability or appearance of cosmetic products. More info. . .→

Fragrance Ingredient/US

Any natural or synthetic substance or substances used solely to impart an odor to a cosmetic product. More info. . .→

pH Adjuster/US

Chemicals (acids, bases, or buffering agents) which are used to control the pH of finished cosmetic products. More info. . .→

If the user clicks on one of the “more information” prompt for “Chelating Agent/EU” the user would see the following information about Chelating Agents based on official EU sources:

Chelating Agent/EU

Added to cosmetic products to react and to form complexes with metal ions which could affect stability and/or appearance of cosmetics.

Chelating agents are chemicals that wrap themselves around metal ions rather like an octopus might envelop its prey. In doing so they effectively remove the metal ion from the cosmetic and prevent it from affecting its appearance, shelf life, or effectiveness.

The most common chelating agents are salts of EDTA (also called edetates), which can be found in almost all soaps, cleansing lotions, shampoos, conditioners, and many other products. They also wrap themselves around calcium and magnesium ions present in hard water and prevent them from forming a powdery scum with some soaps. They are, in effect, softening the hard water.

At the screen listing the ingredients of the Johnson & Johnson Detangling Formula, the user also has the option to select “Safety Factor” which would produce a screen showing the safety factor for the product as a whole and the analysis leading to that result as follows:
Brand: Johnson's [manufactured by Johnson & Johnson]
Product Name: Baby Shampoo Detangling Formula USA
Category: Baby skin care—Shampoo

Safety Factor→

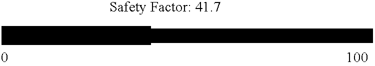

### Product Contains some Ingredients may be Unsafe for use in Cosmetics

### See Details >>>→

| | | |
|---|---|---|
| May cause skin | May have impurities | Do not use |
| sensitivity | linked to breast cancer | on broken skin |
| May cause allergy/contact | | |
| dermatitis | | |

Safety Factor Calculating:

For more Information Click Points

| Points | List of Ingredients |
|---|---|
| 100 | AQUA |
| 0 | COCAMIDOPROPYL BETAINE |
| 0 | PEG-80 SORBITAN LAURATE |
| 100 | SODIUM TRIDECETH SULFATE |
| 0 | PEG-150 DISTEARATE |
| 0 | PARFUM |
| 0 | POLYQUATERNIUM-10 |
| 0 | TETRASODIUM EDTA |
| 0 | QUATERNIUM-15 |
| 100 | CITRIC ACID |
| 100 | RED 40 |
| 100 | YELLOW 10 |

| | | |
|---|---|---|
| Total | Points: | 500 |
| Total | Amount: | 12 |
| Safety Factor: 500/12 = 41.7 | | |

It is noted that the display includes a graphic depiction of the safety factor as well as a textual description.

At this point the user can click on any of the ingredients and get the same screen previously obtained from clicking on one particular ingredient (in the example above it was Red 40 or Citric Acid).

Instead of clicking on “Safety Factor” the user could also have clicked on “Search by Safety Factor” which would produce a screen that includes at least the following information:

[image]

The user then can search all products having a safety factor between 0 and 100, or only, say, shaving cream products having a safety factor between 20 and 60, or only, say, Johnson & Johnson products having a safety factor between 50 and 60, etc. If the user chooses for example to search “face care: eye care” having a safety factor between 0 and 100 the result would be the following screen:

[image]

In one alternative embodiment, the user is also prompted to enter anecdotal safety data experienced about the product after use. For example, if the user experienced an adverse reaction to a skin cream, the user can enter the details of the experience on a screen after prompting. A prompt such as “User's Personal Experience” is clicked which opens a screen allowing the entry of this information. Although the safety data is based on reliable scientific published sources, the additional anecdotal evidence can be incorporated into the software as follows. If a certain number of similar adverse reactions have been sent in anecdotally over the web site regarding a particular cosmetic product, and that reaction can only be caused by one particular ingredient in the product, whereas that ingredient was previously listed as safe it can be subject to warnings and listed as unsafe. Other variations exist in which this anecdotal data can be incorporated into the program. However, in any embodiment the incorporation of the anecdotal data must be done carefully based on an appropriate threshold in magnitude of anecdotal information and not based on a single piece of information. Preferably, the anecdotal information should be consistent with what is scientifically plausible as to what that ingredient could be expected to do. Furthermore, even if the product produces adverse reactions, if it is not known which ingredient causes the reactions then the program would not incorporate the anecdotal data.

In a further alternative embodiment, if there is strong anecdotal information concerning an adverse reaction to a particular cosmetic product, even if it cannot be determined which ingredient causes it, the overall safety factor can be reduced by a predetermined amount.

In an alternative embodiment, the program used in the method and system of the present invention would be used for food or other products rather than for cosmetic products.

It is to be understood that while the method of this invention has been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact steps, construction and/or operation shown and described. The spirit and scope of this invention are limited only by the spirit and scope of the following claims.

What is claimed is:

1. A system for selecting cosmetic products that have a plurality of ingredients, comprising:
an interactive web site accessible through a telecommunications link by users who access a telecommunications network, said interactive web site including at least a display screen that prompts users to input data concerning cosmetic products and cosmetic product ingredients, a database,
software that allows a user to interact with the interactive web site and that allows the interactive web site to respond to the user, said software linked to the database and capable of accessing and using data from the database,
the database including a listing of known cosmetic products and all ingredients of said known cosmetic products and including with respect to each ingredient in each said cosmetic product,
the scientific or botanical name of each ingredient,
the common name of each ingredient,
a categorization of the ingredient as safe or not
specific safety data including at least a summary of known scientific data as to the toxicity of the ingredient, warnings about concentration limitations, warnings about use limitations, side effects,
said database drawing on data concerning known cosmetic product ingredients from published data from scientifically reliable sources located at least in the United States, in Europe, and in Japan,
the software programmed to cause a display screen on the interactive web site to output a safety factor characterizing a degree of safety of a cosmetic product in response to a user at the web site inputting a name of the cosmetic product,
the software programmed to cause a display on the interactive web site of a list of cosmetic products in a particular product category ranked by safety factor,
the software programmed to cause a display on the interactive web site of safety data as to a degree of safety of an ingredient used in a cosmetic product in response to a user at the web site inputting a name of the ingredient, said safety data including at least a status of the ingredient as unsafe or safe, warnings on use, and restrictions on use,
the software programmed to cause a display on the interactive web site of the number and proportion of products of a given brand or manufacturer that have a particular ingredient,
the software programmed to cause a display on the interactive web site of the number and proportion of products in a given product category that have a particular ingredient.

2. The system of claim 1, wherein the interactive web site also allows purchasers of cosmetic products to report anecdotal safety data concerning a cosmetic product on the web site and wherein the database is also formed from anecdotal safety data inputted by purchasers of cosmetic products, said anecdotal safety data including adverse safety data.

3. The system of claim 1, wherein the display of the safety factor of a cosmetic product also includes an analysis of how he safety factor is calculated.

4. The system of claim 1, wherein the safety factor of a particular product is capable of being displayed both textually and graphically.

5. The system of claim 1, wherein the warnings concern concentration limits.

6. The system of claim 5, wherein the warnings also concern use on damaged skin.

7. The system of claim 6, wherein the warnings also concern harmful impurities.

8. The system of claim 7, wherein the warnings also concern possible carcinogens.

9. The system of claim 8, wherein the warnings also concern phototoxicity.

10. The system of claim 9, wherein the warnings also concern whether the ingredient is unsafe for infant skin.

11. The system of claim 10, wherein the warnings also concern allergies and skin sensitivity.

12. The system of claim 11, wherein the warnings also concern formation of nitrosamines in combination with other chemicals.

13. The system of claim 12, wherein the warnings also concern enhancement of exposures to harmful ingredients.

14. The system of claim 13, wherein the warnings also concern effects on the endocrine or reproductive system.

15. The system of claim 14, wherein the warnings also concern whether the cosmetic product is safe to leave on the skin without rinsing the product off after an initial use.

16. The system of claim 15, wherein the warnings concern concentration limits, use on damaged skin, harmful impurities, insufficient testing data, carcinogens and toxicity, acne promoting, eye irritants, phototoxicity, unsafe for infant skin, allergies, sensitization via inhalation, skin sensitivity, formation of nitrosamines in combination with other chemicals, enhancement of exposures to harmful ingredients, effects on endocrine or reproductive system and whether the cosmetic product is unsafe to leave on the skin after an initial use without rinsing off.
